(19) United States
(12) Patent Application Publication
(10) Pub. No.: US 2017/0232350 A1
(43) Pub. Date: Aug. 17, 2017

(54) Multi-Year General Manager Fantasy Sports Game

(71) Applicants: Henry Carrillo, Lowell, OR (US); Christopher Carrillo, Highland, CA (US); Joshua Carrillo, Lowell, OR (US); Jennifer Carrillo, Highland, CA (US)

(72) Inventors: Henry Carrillo, Lowell, OR (US); Christopher Carrillo, Highland, CA (US); Joshua Carrillo, Lowell, OR (US); Jennifer Carrillo, Highland, CA (US)

(21) Appl. No.: 15/043,228

(22) Filed: Feb. 12, 2016

(51) Int. Cl. A63F 13/828; A63F 13/35

(52) U.S. Cl. CPC A63F 13/828; A63F 13/35

(57) ABSTRACT

A method and system of presenting a fantasy sports game includes establishing a league for a fantasy sports game, the league having a predetermined number of teams to participate in the league, receiving requests from fantasy general managers to participate in the league, and assigning teams to the general managers. In the fantasy sports game players that plan to participate in a professional sport draft are the eligible players to be selectable in a fantasy draft for the league. A draft order is set and may be modified by transactions between general managers, and the fantasy draft is conducted prior to the professional sport draft for that season. One or more seasons of the fantasy league is played and a score is calculated for each team in the league. A winner whose team has a highest score among the teams in the league is declared and is paid an award.

### BACKGROUND

1. Field

The disclosed embodiments relate to fantasy sports games. More specifically, the disclosed embodiments relate to methods and systems for presenting fantasy sports games over multiple seasons.

2. Related Art

The Fantasy Sports Trade Association (FSTA) estimates that as of 2014 over 41 million people play fantasy sports in the USA and Canada. The growth of the number of people playing fantasy sports has exploded over the years. In 1988 FSTA estimates there were 500,000 participants. In 2003 that number grew to 15.2 million participating, then to 32 million in 2010. Today FSTA estimates that 41 million people play fantasy sports. Fantasy sports is a $4-5 billion a year industry.

The average fantasy player fits the following demographics: 80% male, 89.8% Caucasian, 51.4% Not Married, Average Age 34, 78.1% with a college degree, 9.51 years in fantasy sports, 17.89 hours consuming sports each week, 8.67 hours consuming fantasy sports each week, 69.4% identify fantasy football as their favorite fantasy sport and 46.9% pay a fantasy sports league fee.

Fantasy sports games, typically played online, allow participants to act as general managers (“GMs”) and compete against other GMs in a fantasy league by building a team by selecting real players within the particular sport. Scoring is comprised using real life player statistics. GMs draft players at different positions to fill the fantasy GM's roster, which translate into points for that fantasy owner based on the player's actual NFL stats. Participants can draft, trade or cut players to shape their roster as they see fit throughout the season to increase their competitive edge over other GMs. The season begins with a league draft where GMs draft from the pool of then existing professional players in that sport. All real life players are eligible, including incoming rookies who have already been drafted and made the rosters of real NFL teams.

There are a variety of different ways to play in fantasy football leagues. Dynasty leagues, salary cap leagues, daily fantasy football leagues and pick a football team leagues are all examples.

Salary cap leagues are leagues that introduce the element of financing and salary caps to each GM. Daily fantasy football leagues allow participants to create a team for a day and compete with other GMs on just that day. Still other fantasy football leagues involve participants simply choosing NFL teams they believe will win that week. Winners move on to future weeks while losers typically get knocked out of the pool of players.

Along with the explosion in fantasy sports participation, interest in the drafting of new players into professional sports leagues has seen a growing interest. For example, the NFL Draft has seen an exponential rise in fan interest. Coverage of the 2014 NFL Draft on NFL Network, ESPN and ESPN 2 reached 45.7 million people across the three-day draft, topping the previous record set in 2010. First round coverage of the 2014 NFL Draft drew a combined total viewership of 32 million viewers, making it the most viewed Round 1 of all time. The 32 million viewers reflected a 28% increase in a single year over 2013 with 25 million viewers. In addition, the 2014 NFL Draft saw significant Twitter traffic increase with more than 9.6 million tweets sent, up 211% from 2013. An average of 10 million people per day viewed tweets about the 2014 NFL Draft.

At the same time that coverage of the three-day NFL Draft has exploded, so too has the pre-draft coverage on television and social media. Today, daily mock NFL drafts begin online several months in advance of the actual NFL Draft and for the first time the demand for additional NFL Draft coverage has led to several primetime television pre-draft shows such as Draft Academy, Finding Giants, Path to the Draft, On the Clock 2015, and many others dedicated solely to scouting outgoing collegiate football talent and analyzing incoming NFL talent in the weeks preceding the NFL Draft. “Finding Giants” for example goes behind the scenes with New York Giants executive scouting staff to discover what it takes to evaluate and draft NFL talent.

The NFL has also capitalized on the rising fan interest by making the NFL Draft one of the biggest sporting events of the year, rivaling that of any other American sporting event. In 2015, the NFL moved the NFL Draft from New York to Chicago for the first time in over 50 years in an effort to bring the NFL Draft on the road and further increase its exposure to NFL fans. Chicago competed for the rights to host the NFL Draft similar to the way Olympic host cities vie for selection, and in response, Chicago orchestrated the most widely attended NFL Draft in its history. Chicago's “Draft Town” was a combination of outdoor activities in Grant Park and the Roosevelt Theatre and drew an unprecedented 200,000 attendees.

As the NFL Draft, as well as other professional sports drafts, continue to grow as a cultural event in American sports, there is no existing fantasy football game dedicated to drafting collegiate or other amateur players entering the leagues as professionals and building a fantasy team thereby.

For example, in fantasy sports leagues known as dynasty keeper leagues, GMs may keep most or all of their players from year to year with an initial first year draft that taps into the existing professional sports player pool. However, even in such dynasty keeper leagues, GMs draft fantasy players from the existing pool of professional sports players currently in the leagues at least in the first year. The GMs thus already know and understand such players' talent because of those players' history in the leagues pre-dating the fantasy dynasty league.

Accordingly, given the growing popularity of both fantasy sports games and professional league drafts, there is a demand for fantasy sports games that include reference to actual drafts of professional sports leagues.

### SUMMARY

This disclosed embodiments comprise a method and system for presenting a game in light of the above. This game presents fantasy sports participants with a challenge unseen before in fantasy games: who is the best General Manager as determined by building the best team from scratch, relying solely on their ability to 1) scout outgoing collegiate or other amateur talent and potential incoming professional talent, 2) draft players at each position for a given sport to fill out a full player roster and 3) trade draft picks and/or players to assemble their team. This game couples this unique challenge with advanced statistics and a variety of unprecedented fantasy features to make for an exciting and novel fantasy game play.

According to one embodiment, a method of presenting a fantasy sports game includes establishing a league for a fantasy sports game, the league having a predetermined number of teams to participate in the league, receiving requests from fantasy general managers to participate in the league, and assigning teams to the general managers. In the fantasy sports game players that plan to participate in a professional sport draft are the eligible players to be selectable in a fantasy draft for the league. A draft order is set and may be modified by transactions between general managers, and the fantasy draft is conducted prior to the professional sport draft for that season. One or more seasons of the fantasy league is played and a score is calculated for each team in the league. A winner whose team has a highest score among the teams in the league is declared and is paid an award.

In further embodiments, when the fantasy sports game is played over a plurality of seasons, an additional fantasy draft is conducted for each season prior to the professional sport draft for that season. Further, after a predetermined number of seasons, players on the rosters of the teams may be selectively retired by the general managers. In addition or in the alternative, after a predetermined number of seasons, players on the rosters of the teams are retired based on whether the players meet an established performance threshold.

A number of the draft picks assigned to the teams in the league may decrease after each season in some embodiments. For example, the fantasy sports game may be a football game where the number of teams is as few as six teams and as many as ten teams. A number of draft picks assigned to the teams in the league may be eighteen in a first season. Thereafter, the number of draft picks assigned to the teams in the league for subsequent fantasy drafts may be fourteen in a second season, twelve in a third season, ten in a fourth season, and seven picks in each of the fifth and sixth seasons.

In a fantasy football embodiment, a number of roster positions on each roster may be twenty-two. The roster positions on each roster may be based on football formations. For example, the formations may include offensive and defensive formations. The offensive formations may include an I-formation, a spread formation, and dual tight end formation, and the defensive formations may include a 4-3 formation, a 3-4 formation, and a nickel formation.

In some embodiments, players in the league may be ranked based on the roster positions, and the score calculated for each team may be based at least in part on rankings of the players on the roster. A bonus may be awarded to a general manager for a player on the roster that is drafted at a pick below a predetermined threshold that also has a player performance ranking above a predetermined threshold. A bonus may further be awarded to a general manager for a player on the roster that receives an actual professional sport award.

In further embodiments, the score may be calculated based on head to head matchups between teams in the league. The score may also be calculated based on a team's performance as compared to all other teams in the league.

In another exemplary embodiment, a system is provided for presenting a fantasy sports game. The system may comprise a server including at least one processor and at least one memory. The memory may have at least one database storing game data. The game data may include statistical data input from a third-party data source for performance of players in a professional sports league. The system may further include at least one presentation device. The presentation device may be communicatively coupled to the server to provide input to the server and receive game information from the server via a network. The presentation device may include at least one input device, at least one display, at least one processor, and at least one memory.

The system may further include machine readable instructions stored on at least one of the server and the at least one presentation device. The instructions, which when executed by the processor of the presentation device or the server, cause the system to establish at least one league for a fantasy sports game, the league having a predetermined number of teams to participate in the league. Requests may be received from fantasy general managers to participate in the league, and teams are assigned from the predetermined number of teams to the general managers. Players are identified that are participating in a professional sport draft as eligible players to be selectable in a fantasy draft for the league.

The system may define a draft order, the draft order comprising a sequence of draft picks assigned to the teams in the league. The fantasy draft may then be conducted with the general managers picking players from the eligible players with the assigned draft picks to form team rosters, the fantasy draft being conducted prior to the professional sport draft. A season in the league for the fantasy sports game may be played based on the rosters formed from the fantasy draft. The fantasy sports game may be played over a plurality of seasons, and prior to each season, an additional fantasy draft is conducted prior to the professional sport draft for that season.

In yet a further exemplary embodiment, a system for presenting a fantasy sports game is provided. The system may comprise a server including at least one processor and at least one memory. The memory may have at least one database storing game data. The game data may include statistical data input from a third-party data source for performance of players in a professional sports league. The system may further include at least one presentation device. The presentation device may be communicatively coupled to the server to provide input to the server and receive game information from the server via a network. The presentation device may include at least one input device, at least one display, at least one processor, and at least one memory.

The system may further include machine readable instructions stored on at least one of the server and the at least one presentation device. The instructions, which when executed by the processor of the presentation device or the server, cause the system establish at least one league for a fantasy sports game, the league having a predetermined number of teams to participate in the league. Requests may be received from fantasy general managers to participate in the league, and teams are assigned from the predetermined number of teams to the general managers. Players are identified that are participating in a professional sport league as eligible players to be selectable in a fantasy draft for the league.

The system may define a draft order, the draft order comprising a sequence of draft picks assigned to the teams in the league. The fantasy draft may then be conducted with the general managers picking players from the eligible players with the assigned draft picks to form team rosters. A season in the league for the fantasy sports game may be played based on the rosters formed from the fantasy draft. A score for each general manager may be calculated based on the statistical data.

In this embodiment, the fantasy sports game is played over a plurality of seasons, and prior to each season, an additional fantasy draft is conducted, and after a predetermined number of seasons, players on the rosters of the teams are retired based on whether the players meet an established performance threshold. In some embodiments, the eligible players to be selectable in a fantasy draft for the league comprise only players that have declared for a professional league draft, and the fantasy draft is conducted prior to the professional draft each season.

### BRIEF DESCRIPTION OF THE DRAWINGS

FIG. 1 shows a process of presenting a fantasy sports game according to one exemplary embodiment.

FIG. 2A is a block diagram illustrating example or representative computing devices and associated computer network.

FIG. 2B is a block diagram of an example embodiment of a mobile computing device.

The components in the figures are not necessarily to scale, emphasis instead being placed upon illustrating the principles of the invention. In the figures, like reference numerals designate corresponding parts throughout the different views.

### DETAILED DESCRIPTION OF EMBODIMENTS

The disclosed embodiments provide new systems and method of fantasy sports gameplay. For example, the embodiments provide a unique experience for fantasy players to create their own “expansion” franchises and compete against others to become the superior general manager (“GM”). A goal according to a preferred embodiment is to assemble the best fantasy team from declared professional sports draftees (e.g. collegiate players who have declared for the NFL Draft or other league draft, but who have yet to be drafted or make an NFL roster). In some embodiments, GMs are not allowed to draft existing professional players, such as current NFL players to their roster as with dynasty keeper leagues. Instead GMs build their team from the ground up using only potential incoming rookies to fill a roster. Thus in this embodiment, game play relies on a GM's ability to scout incoming, potential professional sports talent.

In the following description, the methods and system associated with the embodiments for presenting a new fantasy sports game will be described in relation to a football fantasy sports game based on the NFL. However, it will be appreciated that one skilled in the art will be able to apply the principles explained with reference to the football and the NFL to fantasy sports leagues involving other sports, such as basketball, hockey, baseball, etc.

In the disclosed embodiments, the gameplay challenges fantasy GMs to best scout outgoing collegiate talent and draft the best rookies each year to develop a roster having 22 positions to field an entire NFL team (in the NFL there are 11 offensive starters and 11 defensive starters comprising 22 positions).

The skill level required to effectively scout NFL rookies and successfully draft players who will eventually start and make an impact on a team is one of the greatest challenges every real NFL GM faces in building a team. Walterfootball.com analyzed the first and second rounds of the NFL Draft over a ten-year period from 1998-2007 and found that only 54% of first round draftees and 50% of second round draftees are a hit. Put another way, 46% of first round draftees and 50% of second round draftees ended up as busts in the NFL meaning they did not make a roster, made a roster but did not start or became a limited starter with no meaningful impact on their respective team. Sporting News.com also analyzed the success rate of players drafted in the NFL First Round Draft by determining how many of those draftees made the NFL Pro Bowl (NFL All-Star game) in a single season and in multiple seasons. Over a ten year period from 2002-2012 of the 319 first round NFL draft selections only 31% or 98 made a Pro Bowl once in their NFL career. Only 17% or 55 of the 319 made multiple Pro Bowls in their NFL career. Thus, successfully drafting is one of the greatest challenges in the sport for NFL GMs. This is the same challenge that the game according to the disclosed embodiments presents to its fantasy GMs. That is, one basis of a game according to one embodiment involves scouting incoming NFL talent and building a roster through the NFL draft.

As will be explained in more detail below, the gameplay in some embodiments may be configured to be played over a set period of time encompassing multiple professional seasons. For example, the gameplay may span four years (with an option for up to six years of play). After the set period of time, the team with the most accumulated points that has built the best franchise by scouting prospective talent will prevail as the winner.

In the proposed embodiments, game play may focus on the NFL Draft. In some embodiments gameplay may include the ability for GMs to trade draft picks in order to “move up or down” in their league's annual draft. Just as a real GM has a selection and order of draft picks before the draft that can be traded with other GMs before the pick is selected, one embodiment of the game allows the fantasy football GM an opportunity to trade their draft picks with other GMs.

For example if GM #1 has the 8^{th} draft pick and wants to “move up in the draft” to a better drafting order position, GM #1 can trade its #8 pick and a later pick (e.g. #20^{th} pick) to GM #2 for GM #2's 1^{st} draft pick. Such examples are commonplace in the real NFL Draft where GMs give up multiple draft picks to “move up in the draft” and improve their draft order with a higher pick. GMs in the proposed game can trade picks or players.

In one embodiment, in the first year of the league, each GM has an empty roster. In this embodiments, players will not be available for trade and only draft picks can be traded as in the examples above. In subsequent years two through the final season of the league, such as year six in the league, picks and/or players can continue to be traded to affect the draft order.

In some embodiments, unlike traditional fantasy football games that only score GM's offensive skill players and do not allow the fantasy football fan to enjoy and play with defensive players such as safety, defensive end, defensive tackle, linebackers and cornerbacks and offensive position players such as center, offensive tackles and offensive guards, this proposed fantasy game scores all 22 positions for which each GM is responsible for placing on their roster. As a result, the gameplay allows users to play with both offensive and defensive players. Accordingly, in some embodiments, GMs can play their offensive players versus another GMs defensive players in head-to-head matchups.

According to one embodiment, leagues are provided an option of a rotisserie scoring system that is used to calculate either the entire GM score or a fraction of the GM score. Additionally, the GM competing against others in a “me against the field” scenario determines an additional percentage of a GM's total score. Leagues can decide if they want to play with the basic rotisserie feature and the GM against the field or simply the rotisserie scoring feature. The head to head matchups of a first GM offense versus a second GM defense is another possible scoring metric available to leagues.

In order to score and create a roster for football, it must be determined which positions are desired on the roster. In this embodiment, the gameplay allows the GM to select one of several formations to fill the roster. The different formations may be scored differently depending on the positions included for the formations. Other scoring features may also be added including “Pride Picks,” and Awards and Accolades.

As described in more detail below, GMs may be scored according to three offensive and three defensive formations. Pride Picks reward GMs for those players drafted deep in the draft and who become top players. Further, GMs obtain additional award for drafting players who receive actual NFL season awards and accolades (e.g. Most Valuable Player, Pro Bowl Selection, Rookie of the Year, Rookie of the Week etc.). The NFL has begun to increase visibility to its annual awardees with its introduction of its “NFL Honors” event televised the night before the Super Bowl where its top awards and accolades are given to those deserving players.

As an additional feature in some embodiments, this game includes a player retirement option. The average length of a real player's career in the NFL is three years. Essentially, players who do not make the cut in the NFL are forced into retirement. Similarly, in embodiments of this game, drafted players who do not meet a minimum performance-ranking threshold at their respective position after a predetermined time period (e.g. two years) may be “retired” from the game.

For example, in an eight team league, if a GM's starting running back has a low performance ranking over the first two years, he may be retired from the game heading into the third year such that the GM replace the player with a better player. In some embodiments, the threshold is set higher, and retirement is made mandatory, so that the GM will no longer be able to utilize that player at the running back position to accrue points for the GM's team in the third, fourth, fifth or sixth years. This feature challenges GMs to continuously draft effective players to simulate the job of an actual NFL GM. It also continues to place the focus on incoming rookies and scouting prospective professional talent as GMs in the third year will begin to lose those two-year veteran players they drafted in the first year and will be forced to have to replace them with Year three rookies.

Advantages

The disclosed embodiments provide a number of advantages including at least the following:

1. The fantasy sports game such as fantasy football provides an experience that focuses on the NFL Draft as well as the NFL season, giving participants 365 days of “play” because it is not solely NFL season based.

2. Participants may build a fantasy team through the NFL Draft by scouting collegiate talent and/or other potential incoming NFL talent to field the best team over a predetermined number of seasons (e.g. four years with the option for gameplay up to six years).

3. The embodiments provide a game that targets both the professional and amateur or collegiate sports fan market.

4. Participants may play with more players at all positions as compared to traditional fantasy football games. For football, this includes playing with an eleven man defensive roster and with players at every NFL position.

5. By scoring all positions, head to head matchups of offense vs. defense are possible.

6. Advanced statistics used to accurately reflect the quality of a player at each position and their weekly performance.

7. Optional scoring methods may be used separately or in combination including a “Me against the field” scoring criteria, rotisserie, and head to head games. In “Me against the field,” GMs compete weekly against the entire field of league GMs for a weekly ranking.

8. Bonus scoring and other optional features are provided such as Pride Picks, Retired Players, and scoring criteria utilizing NFL Awards & Accolades.

9. Incentivized scoring options are provided for GMs with the top player at each position, rewarding additional points for the best player at that position.

10. Scoring options are provided utilizing different offensive and defensive formations weighted separately to tabulate each GM's total offensive and defensive scores.

Gameplay

Methods and systems for presenting a fantasy sports games incorporating the above described features will now be described in more detail. As mentioned above, the game according to the disclosed embodiments encompasses a fixed period, multiple season fantasy sports game that allows participants to compete as a GM building their “expansion” team from the ground up using a pool of perspective professional athletes declared for a professional sports league draft as the primary tool to acquire its roster.

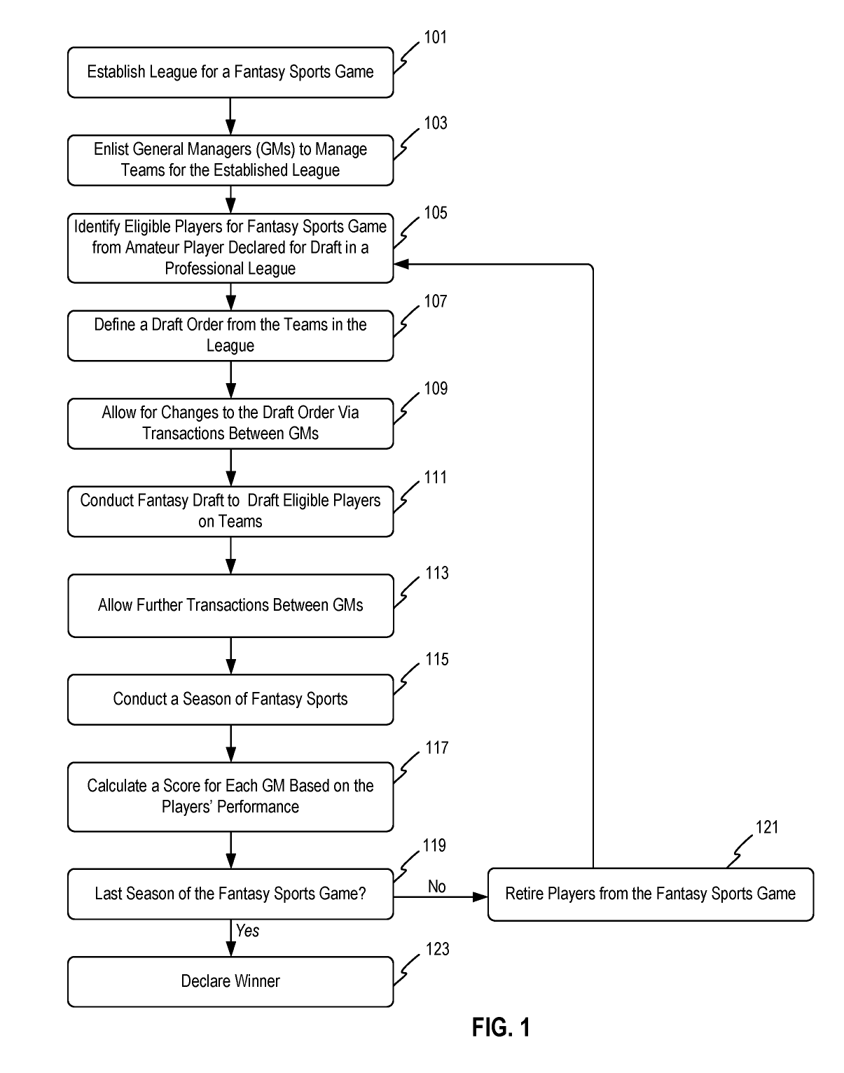

FIG. 1 shows a process flow for presenting a fantasy sports game according to one exemplary embodiment. The fantasy sports game may be presented in a number of different ways. For example, a fantasy sports game may be presented by one or more servers executing program instructions to present the game to one or more participants via the participant's game presentation device. The game presentation device may be any one of a personal computer, tablet computing device, portable computing device, smart phone, or other device. The game may be conducted over a network such as the internet to allow participation of multiple remote participants.

In step 101, a league is established, for example on a game server. The league may be established to have a predetermined number of teams, particular game rules, scoring rules, and time period. For example, the league may be set to have a “me against the field” scoring system, have eight teams, and have longevity of four years.

Next, in step 103, participants may join a league and the various teams in the fantasy league are established. On a server or cloud based game, participants may be assigned to the league randomly by the server, or groups of people may sign up together. In this manner, flexible game play may be facilitated either for an individual participant looking for a league to play, or for a group of friends who want to compete against one another in the same league.

Once the league is established with a sufficient number of teams in the league, league play may begin. In step 105, the system identifies all eligible players for a fantasy game draft. For example, the system may identify all players that have declared for a professional league draft, such as the NFL or NBA draft. The players may include collegiate players, semi-professional players, international players, or the like. Unlike traditional fantasy game, the existing professional pool of players is not available for the fantasy game draft.

In step 107, teams in the fantasy sports league are assigned a draft order. The draft order of teams may be assigned randomly by the server at the beginning of the game. During subsequent seasons, the draft order may be assigned based on the results of the previous season. For example, the winning participant's team of one season may be awarded for his/her success with a high draft order in the next season. In another embodiment, the draft order in subsequent seasons may give preference to the losing teams in the game to balance the teams and make the game more challenging. In further embodiments, all seasons' draft orders may be random, or may be chosen by a weighted lottery, or the like.

Once the draft order is set, and before drafting in the league begins, there is a predetermined time period where changes to the draft order may be made by the participants or the GMs of the various teams in step 109. For example, in an eight team league, a GM X may have the eighth overall draft pick and may wish to move up in the draft to the first overall pick. In this scenario, he may propose to trade the eighth pick combined with a subsequent pick with the player holding the first pick (e.g. GM Y). If such a trade is agreed upon between the GMs, the GM X will have gained a better draft position in the first round while GM Y will have gained an extra draft pick and will now have an increase in total draft picks for that year.

In some embodiments, there may be a commissioner for a league to approve of such transactions. In other embodiments, there may be no limit to transactions, and trades that GMs negotiate among themselves are considered fair. In other embodiments, there may be a cap on total trades, such as two trades per GM per season.

Once any transactions have been made and the final draft order is set, the fantasy league conducts the player draft in step 111. In the first year each fantasy GM starts with an empty roster and is given a predetermined number of draft picks to begin to fill out the roster on his or her team. In one embodiment of a fantasy football league, the GM is allotted eighteen pics to draft eighteen players from the pool of amateur players who have declared and are eligible for the NFL draft to start filling 22 roster positions on their team, eleven offensive players and eleven defensive players. In some embodiments, to cater to the college fan base, only former collegiate players who are eligible to be drafted by the NFL and who have yet to be drafted by NFL teams can be added to participant's rosters.

In a preferred embodiment, the fantasy draft is conducted prior to the actual draft in the actual professional sports league. This ensures GMs have no insight into whether the real draftees will be drafted to good teams, bad teams or not drafted at all. These factors can affect a player's performance during fantasy league play, and therefore this timing purifies the goal of determining which GM has the most skill at selecting draftees to field its team. However, in other embodiments, the draft may occur after the professional draft so that the GMs have access to the actual draft order.

When the draft has been completed, there may optionally be a predetermined time period in which player transactions may be made by the GMs in step 113. That is, the GMs may trade the players that they drafted in attempt to better their teams. In some embodiments, GMs are allowed to trade roster players from the end of the draft to the day before the actual professional season begins. In other embodiments, there may be a trade cap of two players per GM per year. In still further embodiments, trades may only be made during certain time periods, such on Tuesdays and Wednesdays between weeks in the NFL, or before a trade deadline midway through the seasons. Other now known or later developed regulations on player transactions may also be included. However, in leagues where emphasis is placed on drafting rookies, this step may be omitted, so that the outcome of the game is focused more on the ability to draft incoming talent onto a fantasy team.

In step 115, the professional season commences and play in the fantasy sports game based on player performance is conducted. In some embodiments, the GMs may be required to choose their starting lineup before the start of the actual professional season. Those players on the roster but not selected in the starting lineup may not receive points toward the GM's score. In some embodiment, GMs may also be allowed the option to move up to four bench players into the starting lineup at the end of the season before the final points are awarded for that year to the respective GM. This allows flexibility for a GM who had a player on the bench who outperformed the starter that the GM selected, and who otherwise would not contribute to the GM score. This option also allows a GM to move a starter at a particular position to a different starter position if the player ended up playing at another position. In some embodiments, the option for bench players may be negotiable and may carry over to the next season. Accordingly, the option to promote a bench player may be traded to other GMs for future years use by that GM for draft picks or players.

In other embodiments, the GMs may be required to choose their starting lineups on a week to week basis, such as prior to the games beginning on a certain day each week. In this embodiment, only starters are scored on the weeks where they are selected in the lineup, and there is no option of including bench players in the scoring for that particular week.

Next, in step 117, an overall score for the teams participating in the league is calculated once the gameplay for a particular season is completed. In one embodiment as applied to a fantasy football game, each GM's annual score is calculated by adding up a GM player score and GM bonus score. The GM player score may be calculated by adding the rankings of all twenty-two football positions on the GM's roster. Bonus points may be calculated based on any actual NFL awards granted to players on the GM's roster.

In other embodiments, during each week of the NFL season, GMs have the option of playing in a head-to-head matchup where GM1 can play his offensive players versus GM2's defensive players. For those leagues that choose to include the GM's team ranking against other GM's teams based off of competing against the GM field each week that scoring constitutes a fraction of the GM score.

In this embodiment, the fantasy football game accumulates scoring for 22 positions: 11 on offense and 11 on defense just as in a real football game. Each player on a team who is designated to a position receives a point ranking depending on his rank among other players in his position, which is a component of the GM's total score. For example, if a cornerback is ranked as the best at his position in an eight team league, then the GM for that player would receive 8 points for that position. In some embodiments, the GM may also receive an additional 2 points as a reward for drafting the best player at the cornerback position. If a GM had the worst ranked cornerback he may receive only 0.33 of a point. In another example, if a league has six teams, then the scoring would range from 0.33-6 points for each of the 22 positions, with 6 points being allotted to the GM with the best player at that position plus the additional 2 reward points.

In this game, it is possible that players drafted in the fantasy draft may not actually be drafted in the real draft, may not make an NFL roster after training camp, or otherwise may not end up playing in an NFL game. If such a player is drafted and included on a roster in the fantasy game, then the GM receives 0 points at that position. If a GM has more than one player at a given position, the GM must designate a “starting” player for that position as mentioned above. Ideally the GM will use the player with the best stats at that position to serve as the GM's “starter” or active player for that position. Although a GM may have a superior player for that position on his roster, only the designated player will be scored against other GMs' players for that position. The 22 positions are added to give the GM a total player point score.

In addition to the rotisserie scoring, leagues can decide if they want to employ heads up gameplay where GMs may play a GM1 offense against a GM2 defense. In a first year where rosters may not be complete, a heads up matchup may include GM1 picking his best 8 offensive players versus GM2's best eight defensive players. In the subsequent years, head-to-head gameplay may employ the full 11 players versus 11 players that you see in a real NFL game.

In some embodiments, a combination of scoring systems may be used. For example, if the league opts to include the GM against the field option, in addition to the rotisserie style scoring for each player position, up to 25% of each GM score may result from how their team does versus the other teams in their league each week. For example in Week 1, with eight teams in a league, the team that scores the best compared to the other seven teams will receive a score of 8. The second best team will receive a score of 7 and so on until the worst team receives a score of 1. All eighteen weeks and the corresponding score ranking per team is averaged. Up to 25% of each GM score will result from how their team does versus others.

In some embodiments, scoring may factor in real life NFL awards and accolades for each GM team. After each GM player score is tallied for the 22 player positions, each GM is eligible for additional bonus points at the end of the year depending on whether players on their roster received real life NFL awards and accolades. For example if a player on a GM roster won the NFL Rookie of the Year for that year, the GM for that player would receive 12 additional points. If a player was selected to the NFL Pro Bowl, then that GM would receive 10 points.

A “pride pick” is also available to that GM that selected a player in the draft with a low draft pick that became an impact player in the NFL. A GM is eligible for pride pick points if that GM selected a player in the bottom 25% of all draft picks for that draft year and where that player selected at the end of the first year ended up as a top five ranked player at his particular position.

For example in a draft with 144 players (18 picks available to 8 league GMs) a pride pick would be eligible to those GMs that drafted a player in draft order 108-144 and who performed as a top five ranked player at their position. There are no limits to the number of pride picks awarded each year. Pride picks continue to be eligible for GMs in the second year for those players they drafted in the first year and for GMs selecting a new class of rookies in the second, third and fourth seasons. In some embodiments, if a GM trades a player who was a pride pick for them, the new GM inheriting that player is not eligible for pride pick points. Table 1 shows an example breakdown of eligible bonus points for GMs in a fantasy football embodiment:

TABLE 1

| Award | Points |
|---|---|
| Player of the Week Honors | 1 point |
| Player of the Month Honors | 3.5 points |
| Rookie of the Month Honors | 2 points |
| Pro Bowl Start | 10 points |
| Pro Bowl Alternate | 7.5 points |
| Offensive Rookie of the Year | 12 points |
| Defensive Rookie of the Year | 12 points |
| Offensive Player of the Year | 15 points |
| Defensive Player of the Year | 15 points |
| NFL Most Valuable Player | 20 points |
| Super Bowl MVP | 5 points |
| Pride Pick | 3.5 points |

In another embodiment, combined scoring may be a weighted score. Assuming a league commissioner opts in, each GM score is a combination of its player score (points accrued for the 22 roster positions) (minimum of 75%)+GM against the field score (up to 25%). Any applicable NFL Awards & Accolades bonus points are added to GM's scores which will be included within the 75% roster score.

Unlike traditional fantasy sports leagues, the game according to the disclosed embodiments grades every player on both offense and defense in a fantasy football type game. Eleven offensive positions and eleven defensive positions are scored for a total of 22 fantasy positions. The positions scored are shown in Table 2:

TABLE 2
Scored Positions:

```
  1. Quarterback
  2. Running Back
  3. Wide Receiver
  4. Center
  5. Offensive Guard
  6. Offensive Tackle
  7. Tight End
  8. Defensive End
  9. Defensive Tackle
10. Outside Linebacker
11. Inside Linebacker
12. Cornerback
13. Safety
```

In the actual NFL, teams utilize a variety of offensive and defensive formations. In some embodiments, the game presents a similar challenge to its GMs. The game may preferably use three offensive formations (e.g. “I formation” “spread offense” and “dual tight end”) and three defensive formations (e.g. “4-3” “3-4” and the “nickel”) that may be used to tabulate each GMs total offense and defense team score where each of the three formations are weighted 33% toward team offensive score and 33% toward team defensive score. For example, an offensive “I formation” uses two running backs and two wide receivers. However, a “spread offense” formation that is very popular in the NFL drops the second running back from the starting lineup that the I formation uses and inserts a third wide receiver as the eleventh offensive player. A third widely used offensive formation in the NFL adds an additional tight end and drops a running back from the I formation lineup. In this manner, the game challenges its GMs to have to draft and build their teams keeping in mind the three most widely utilized offensive and defensive formations that actual NFL teams and actual GMs must consider in building their NFL teams.

In one embodiment, an add-on feature may also be utilized which may be referred to as Alpha All-Stars. Alpha All-Stars may permit league GMs to rank and compare their players' top single game performances separate from players' overall seasonal statistical output. For example, if a first running back were to rush for 275 yards and three touchdowns and that was the single game top performance for his position, the first running back would be designated as an Alpha-All Star performer, and the GM who drafted the first running back would receive additional bonus points. In essence, Alpha-All Stars rewards the top single game performances of the NFL season.

Once a score for each team in the league is calculated, the system determines whether the final season of league play has been completed in step 119. If the season is not the last season, the game is not yet complete, and the process proceeds to step 121. In step 121, players may be removed from the league by forced or elective player retirement. In the NFL, the average length of a player's career in the NFL is three years. Players who do not make the cut in the NFL are forced into retirement. Similarly, in this game, players who do not meet a minimum performance-ranking threshold at their respective position after two years will be “retired” from the game.

For example, in an eight team league, if a GM's starting running back has a 2.0 performance ranking over the first two years he will be retired from the game heading into the third year, and that GM will no longer be able to utilize that player at the running back position to accrue points for the GM's team in subsequent years. Of course, any other threshold or time period may be set according to league preferences.

By including a mandatory retirement feature, the GM is challenged to continuously draft effective players and makes the game more similar to the actual NFL. It also continues to place the focus on rookies and scouting incoming collegiate talent as GMs in the third year will begin to lose those two-year veteran players they drafted in year 1 and will be forced to replace them with year 3 rookies.

In some embodiments, after a season is over, the GMs may also electively waive players from their rosters. For example, if a GM expects that a player who is not retired by the mandatory performance requirements will not perform well the next year, the GM may remove the player from the roster in place of a new player to be drafted in the next draft.

Once player retirement is complete, the process returns to step 105 to begin drafting new eligible players for the next year. In subsequent years, those players that the GM drafted and/or traded with other GMs in the previous year remain on their roster. The GM begins the subsequent year drafting another set of incoming NFL rookies depending on the needs of their team to start filling the positions with the best available talent. The subsequent years may follow the same method as explained above.

In further embodiments, as each GM adds to its roster each year, the number of draft picks available to each GM decreases. For example in a fantasy football league, each GM has 18 picks in the first year, stepping down to 14 in the second year, 12 in the third year and 10 picks in the fourth year. In this example there a total of 54 draft picks over 4 years to build and maintain a roster of 22 position players.

In this example, as GMs make their way into seasons two, three, and four they have fewer picks to complete their roster, increasing the challenge of building the best team and becoming the best GM. For a fantasy football embodiment, this game may be played with six to ten GMs per league. Due to the finite number of collegiate players drafted each year in the NFL, leagues with ten GMs at 18 picks per GM (180 draft picks) would allow almost all collegiate players to be drafted in this game since there are roughly 210 college players drafted each year.

Similar limitations on the number of players drafted would affect the fantasy sports games for other sports. Additionally, scoring may be modified for professional leagues that customarily send some or most rookies to a minor league or a development league. For example, players making the professional league may be ranked, followed by players ranked in a subsequent level of minor leagues, and so on.

In another proposed embodiment, there is a “fantasy handicap” score comparable to a handicap score in golf as a way of judging fantasy GMs across multiple leagues. The handicap would allow a fantasy participant to compare and even compete based on their handicap score with others across the country. This embodiment would calculate a fantasy handicap by determining a fantasy GM participant's average ranking per position across all 22 positions. Each GM participant's ranking at each of the 22 positions would be tallied and then divided by 22 to get the fantasy handicap.

For example, if participant A had the best quarterback they would receive a “1” for that position, which would be added to the “3” ranking for the running back position because they had the third highest ranked running back. This process of adding the rankings at each position would continue for the other 20 positions and a total ranking score of for example 90 would have accumulated. 90/22 equals 4.09. Participant A's handicap would be 4.09. The lower the handicap the better. The rankings of positions would calculated from all eligible players that were available to be drafted in the NFL not from all players drafted in that particular fantasy GM league. In this way there is a standardized measurement to compare fantasy GM participants across all leagues in the country.

A fantasy handicap would be a source of pride and bragging rights amongst fantasy GM participants, would allow participants to compare their GM drafting strength outside their respective league with other fantasy GMs across the country, and enable a way for the best fantasy GMs to be graded and selected for possible tournament play outside of league play.

Returning to step 119, after the last season has been played, the process proceeds to step 123. In step 123, total scores over the course of the predetermined number of seasons is calculated, and the GM with the highest overall score is declared the winner.

The disclosed embodiments provide a unique gameplay experience for the participants. Traditional fantasy football games are played only for the duration of the NFL season. However, the game according to the disclosed embodiments may be experienced all year long. For example in a fantasy football game, before the NFL draft, GMs scout and research players for the draft in April. From April to September, GMs monitor their draftees to see who made NFL rosters. From September to February GMs monitor player performances during the heart of the NFL season. After the season, GMs may again resume scouting.

Since each GM is building their team over predetermined number of seasons (e.g. four years or up to 6 years for leagues that elect a longer gameplay) and is keeping the players that they draft on their team in year one into subsequent years, this game will add each annual score and after four years (or six years) the GM with the most points is the winner.

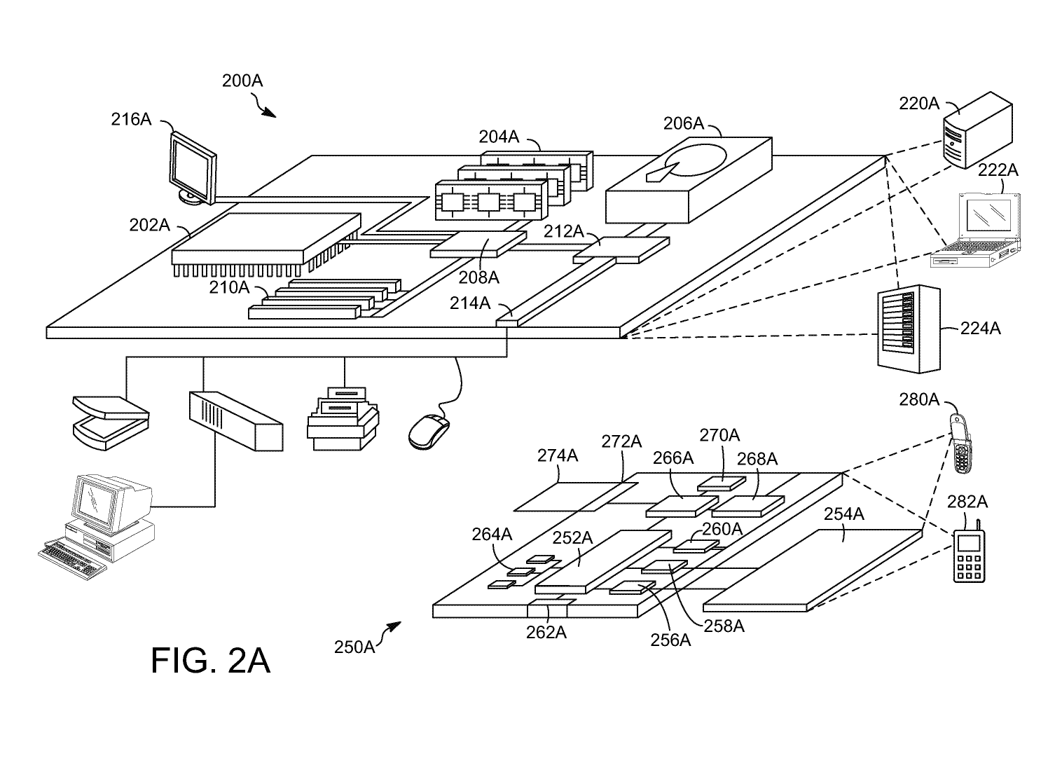

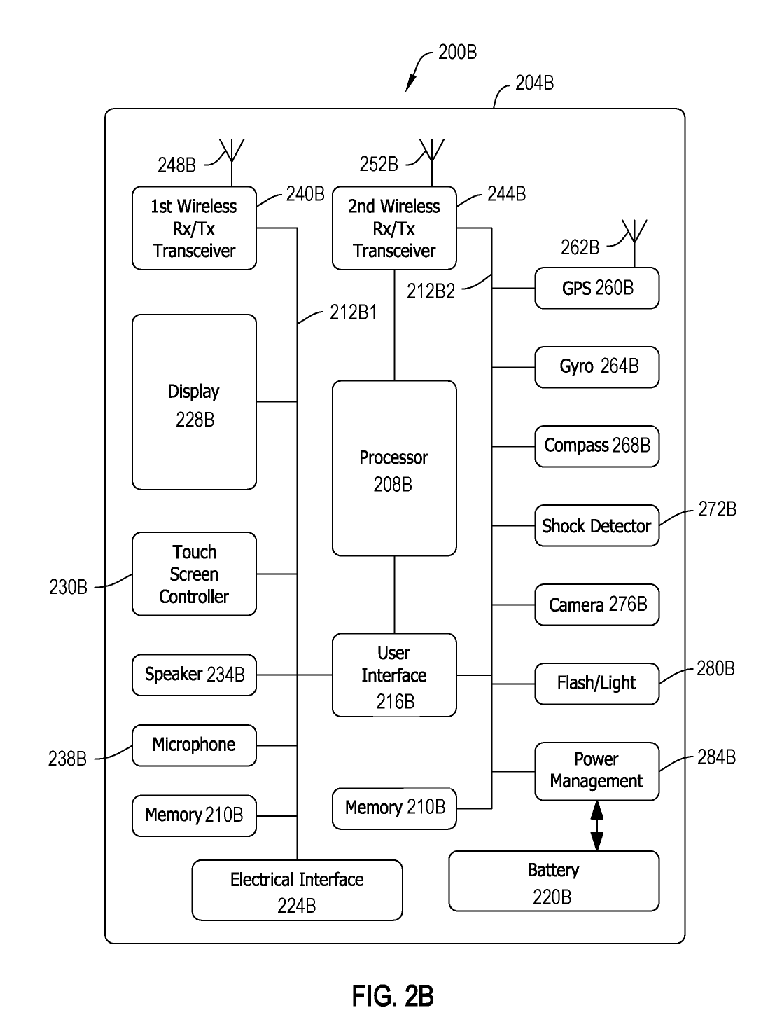

FIG. 2A is a block diagram showing example or representative computing devices and associated elements that may be used to implement the systems method and apparatus described herein. FIG. 2A shows an example of a generic computing device 200A and a generic mobile computing device 250A, which may be used with the techniques described here. Computing device 200A is intended to represent various forms of digital computers, such as laptops, desktops, workstations, personal digital assistants, servers, blade servers, mainframes, and other appropriate computers. Computing device 250A is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 200A includes a processor 202A, memory 204A, a storage device 206A, a high-speed interface or controller 208A connecting to memory 204A and high-speed expansion ports 210A, and a low-speed interface or controller 212 connecting to low-speed bus 214A and storage device 206A. Each of the components 202A, 204A, 206A, 208A, 210A, and 212A, are interconnected using various busses, and may be mounted on a common motherboard or in other manners as appropriate. The processor 202A can process instructions for execution within the computing device 200A, including instructions stored in the memory 204A or on the storage device 206A to display graphical information for a GUI on an external input/output device, such as display 216A coupled to high-speed controller 208A. In other implementations, multiple processors and/or multiple buses may be used, as appropriate, along with multiple memories and types of memory. Also, multiple computing devices 200A may be connected, with each device providing portions of the necessary operations (e.g., as a server bank, a group of blade servers, or a multi-processor system).

The memory 204A stores information within the computing device 200A. In one implementation, the memory 204A is a volatile memory unit or units. In another implementation, the memory 204A is a non-volatile memory unit or units. The memory 204A may also be another form of computer-readable medium, such as a magnetic or optical disk.

The storage device 206A is capable of providing mass storage for the computing device 200A. In one implementation, the storage device 206A may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 204A, the storage device 206A, or memory on processor 202A.

The high-speed controller 208A manages bandwidth-intensive operations for the computing device 200A, while the low-speed controller 212A manages lower bandwidth-intensive operations. Such allocation of functions is exemplary only. In one implementation, the high-speed controller 208A is coupled to memory 204A, display 216A (e.g., through a graphics processor or accelerator), and to high-speed expansion ports 210A, which may accept various expansion cards (not shown). In the implementation, low-speed controller 212A is coupled to storage device 206A and low-speed bus 214A. The low-speed bus 214, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 200A may be implemented in a number of different forms, as shown in the figure. For example, it may be implemented as a standard server 220A, or multiple times in a group of such servers. It may also be implemented as part of a rack server system 224A. In addition, it may be implemented in a personal computer such as a laptop computer 222A. Alternatively, components from computing device 200A may be combined with other components in a mobile device (not shown), such as device 250A. Each of such devices may contain one or more of computing device 200A, 250A, and an entire system may be made up of multiple computing devices 200A, 250A communicating with each other.

Computing device 250A includes a processor 252A, memory 264A, an input/output device such as a display 254A, a communication interface 266A, and a transceiver 268A, among other components. The device 250A may also be provided with a storage device, such as a microdrive or other device, to provide additional storage. Each of the components 250A, 252A, 264A, 254A, 266A, and 268A, are interconnected using various buses, and several of the components may be mounted on a common motherboard or in other manners as appropriate.

The processor 252A can execute instructions within the computing device 250A, including instructions stored in the memory 264A. The processor may be implemented as a chipset of chips that include separate and multiple analog and digital processors. The processor may provide, for example, for coordination of the other components of the device 250A, such as control of user interfaces, applications run by device 250A, and wireless communication by device 250A.

Processor 252A may communicate with a user through control interface 258A and display interface 256A coupled to a display 254A. The display 254A may be, for example, a TFT LCD (Thin-Film-Transistor Liquid Crystal Display) or an OLED (Organic Light Emitting Diode) display, or other appropriate display technology. The display interface 256A may comprise appropriate circuitry for driving the display 254A to present graphical and other information to a user. The control interface 258A may receive commands from a user and convert them for submission to the processor 252A. In addition, an external interface 262A may be provide in communication with processor 252A, so as to enable near area communication of device 250A with other devices. External interface 262A may provide, for example, for wired communication in some implementations, or for wireless communication in other implementations, and multiple interfaces may also be used.

The memory 264A stores information within the computing device 250A. The memory 264A can be implemented as one or more of a computer-readable medium or media, a volatile memory unit or units, or a non-volatile memory unit or units. Expansion memory 274A may also be provided and connected to device 250A through expansion interface 272A, which may include, for example, a SIMM (Single In Line Memory Module) card interface. Such expansion memory 274A may provide extra storage space for device 250A, or may also store applications or other information for device 250A. Specifically, expansion memory 274A may include instructions to carry out or supplement the processes described above, and may include secure information also. Thus, for example, expansion memory 274A may be provide as a security module for device 250A, and may be programmed with instructions that permit secure use of device 250A. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 264A, expansion memory 274A, or memory on processor 252A, that may be received, for example, over transceiver 268A or external interface 262A.

Device 250A may communicate wirelessly through communication interface 266A, which may include digital signal processing circuitry where necessary. Communication interface 266A may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 268A. In addition, short-range communication may occur, such as using a Bluetooth, Wife, or other such transceiver (not shown). In addition, GPS (Global Positioning system) receiver module 270A may provide additional navigation- and location-related wireless data to device 250A, which may be used as appropriate by applications running on device 250A.

Device 250A may also communicate audibly using audio codec 260A, which may receive spoken information from a user and convert it to usable digital information. Audio codec 260A may likewise generate audible sound for a user, such as through a speaker, e.g., in a handset of device 250A. Such sound may include sound from voice telephone calls, may include recorded sound (e.g., voice messages, music files, etc.) and may also include sound generated by applications operating on device 250A.

The computing device 250A may be implemented in a number of different forms, as shown in the figure. For example, it may be implemented as a cellular telephone 280A. It may also be implemented as part of a smart phone 282A, personal digital assistant, a computer tablet, or other similar mobile device.

Thus, various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system (e.g., computing device 200A and/or 250A) that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In the example embodiment, computing devices 200A and 250A are configured to receive and/or retrieve electronic documents from various other computing devices connected to computing devices 200A and 250A through a communication network, and store these electronic documents within at least one of memory 204A, storage device 206A, and memory 264A. Computing devices 200A and 250A are further configured to manage and organize these electronic documents within at least one of memory 204A, storage device 206A, and memory 264A using the techniques described herein.

FIG. 2B illustrates an example embodiment of a mobile device 200B. This is but one possible device configuration, and as such it is contemplated that one of ordinary skill in the art may differently configure the mobile device. The device 200B may comprise any type of fixed or mobile communication device that can be configured in such a way so as to function as described below. The mobile device may comprise a PDA, cellular telephone, smart phone, tablet PC, wireless electronic pad, or any other computing device.

In this example embodiment, the mobile device 200B is configured with an outer housing 204B that protects and contains the components described below. Within the housing 204B is a processor 208B and a first and second bus 212B1, 212B2 (collectively 212B). The processor 208B communicates over the buses 212B with the other components of the mobile device 200B. The processor 208B may comprise any type of processor or controller capable of performing as described herein. The processor 208B may comprise a general purpose processor, ASIC, ARM, DSP, controller, or any other type processing device.

The processor 208B and other elements of the mobile device 200B receive power from a battery 220B or other power source. An electrical interface 224B provides one or more electrical ports to electrically interface with the mobile device 200B, such as with a second electronic device, computer, a medical device, or a power supply/charging device. The interface 224B may comprise any type of electrical interface or connector format.

One or more memories 210B are part of the mobile device 200B for storage of machine readable code for execution on the processor 208B, and for storage of data, such as image data, audio data, user data, medical data, location data, shock data, or any other type of data. The memory may store the messaging application (app). The memory may comprise RAM, ROM, flash memory, optical memory, or micro-drive memory. The machine readable code as described herein is non-transitory.

As part of this embodiment, the processor 208B connects to a user interface 216B. The user interface 216B may comprise any system or device configured to accept user input to control the mobile device. The user interface 216B may comprise one or more of the following: keyboard, roller ball, buttons, wheels, pointer key, touch pad, and touch screen. A touch screen controller 230B is also provided which interfaces through the bus 212B and connects to a display 228B.

The display comprises any type of display screen configured to display visual information to the user. The screen may comprise an LED, LCD, thin film transistor screen, OEL CSTN (color super twisted nematic), TFT (thin film transistor), TFD (thin film diode), OLED (organic light-emitting diode), AMOLED display (active-matrix organic light-emitting diode), capacitive touch screen, resistive touch screen or any combination of these technologies. The display 228B receives signals from the processor 208B and these signals are translated by the display into text and images as is understood in the art. The display 228B may further comprise a display processor (not shown) or controller that interfaces with the processor 208B. The touch screen controller 230B may comprise a module configured to receive signals from a touch screen which is overlaid on the display 228B. Messages may be entered on the touch screen 230B, or the user interface 216B may include a keyboard or other data entry device.

Also part of this exemplary mobile device is a speaker 234B and microphone 238B. The speaker 234B and microphone 238B may be controlled by the processor 208B and are configured to receive and convert audio signals to electrical signals, in the case of the microphone, based on processor control. Likewise, processor 208B may activate the speaker 234B to generate audio signals. These devices operate as is understood in the art and as such are not described in detail herein.

Also connected to one or more of the buses 212B is a first wireless transceiver 240B and a second wireless transceiver 244B, each of which connect to respective antenna 248B, 252B. The first and second transceiver 240B, 244B are configured to receive incoming signals from a remote transmitter and perform analog front end processing on the signals to generate analog baseband signals. The incoming signal may be further processed by conversion to a digital format, such as by an analog to digital converter, for subsequent processing by the processor 208B. Likewise, the first and second transceiver 240B, 244B are configured to receive outgoing signals from the processor 208B, or another component of the mobile device 208B, and up-convert these signal from baseband to RF frequency for transmission over the respective antenna 248B, 252B. Although shown with a first wireless transceiver 240B and a second wireless transceiver 244B, it is contemplated that the mobile device 200B may have only one such system or two or more transceivers. For example, some devices are tri-band or quad-band capable, or have Bluetooth and NFC communication capability.

It is contemplated that the mobile device, and hence the first wireless transceiver 240B and a second wireless transceiver 244B may be configured to operate according to any presently existing or future developed wireless standard including, but not limited to, Bluetooth, WI-FI such as IEEE 802.11 a,b,g,n, wireless LAN, WMAN, broadband fixed access, WiMAX, any cellular technology including CDMA, GSM, EDGE, 3G, 4G, 5G, TDMA, AMPS, FRS, GMRS, citizen band radio, VHF, AM, FM, and wireless USB.

Also part of the mobile device is one or more systems connected to the second bus 212B which also interfaces with the processor 208B. These devices include a global positioning system (GPS) module 260B with associated antenna 262B. The GPS module 260B is capable of receiving and processing signals from satellites or other transponders to generate location data regarding the location, direction of travel, and speed of the GPS module 260B. GPS is generally understood in the art and hence not described in detail herein.

A gyro 264B connects to the bus 212B to generate and provide orientation data regarding the orientation of the mobile device 204B. A compass 268B, such as a magnetometer, provides directional information to the mobile device 204B. A shock detector 272B, which may include an accelerometer, connects to the bus 212B to provide information or data regarding shocks or forces experienced by the mobile device. In one configuration, the shock detector 272B generates and provides data to the processor 208B when the mobile device experiences a shock or force greater than a predetermined threshold. This may indicate a fall or accident.

One or more cameras (still, video, or both) 276B are provided to capture image data for storage in the memory 210B and/or for possible transmission over a wireless or wired link or for viewing at a later time. The processor 208B may process image data to perform image recognition, such as in the case of, facial detection, item detection, facial recognition, item recognition, or bar/box code reading.

A flasher and/or flashlight 280B are provided and are processor controllable. The flasher or flashlight 280B may serve as a strobe or traditional flashlight, and may include an LED. A power management module 284 interfaces with or monitors the battery 220B to manage power consumption, control battery charging, and provide supply voltages to the various devices which may require different power requirements.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included. For example, while one application of a fantasy sports game has been referred to throughout, other applications of the above embodiments include online or web-based applications or other cloud services.

Also, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “identifying” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the invention may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A method of presenting a fantasy sports game via a server to one or more presentation devices, the method comprising:
establishing at the server at least one league for a fantasy sports game, the league having a predetermined number of teams to participate in the league;
receiving at the server requests from fantasy general managers to participate in the league;
assigning at the server teams from the predetermined number of teams to the general managers;
identifying at the server players that are participating in a professional sport draft as eligible players to be selectable in a fantasy draft for the league;
defining at the server a draft order, the draft order comprising a sequence of draft picks assigned to the teams in the league.
receiving at the server from the presentation devices of the general managers requests to make transactions between the general managers to change the draft order;
conducting at the server via input received from the presentation devices the fantasy draft, the general managers picking players from the eligible players with the assigned draft picks to form team rosters, the fantasy draft being conducted prior to the professional sport draft;
playing via the server a season in the league for the fantasy sports game;
calculating via the server a score for each team in the league for the fantasy sports game;
declaring a winner and paying an award to the winner via the server to the general manager whose team has a highest score among the teams in the league.

2. The method of claim 1, wherein the fantasy sports game is played over a plurality of seasons, and prior to each season, an additional fantasy draft is conducted prior to the professional sport draft for that season.

3. The method of claim 2, wherein after a predetermined number of seasons, players on the rosters of the teams are selectively retired by the general managers.

4. The method of claim 2, wherein after a predetermined number of seasons, players on the rosters of the teams are retired based on whether the players meet an established performance threshold.

5. The method of claim 2, wherein a number of the draft picks assigned to the teams in the league decreases after each season.

6. The method of claim 2, wherein the fantasy sports game is a football game and the predetermined number of teams is as few as six teams and as many as ten teams.

7. The method of claim 6, wherein a number of draft picks assigned to the teams in the league is eighteen.

8. The method of claim 7, wherein the number of draft picks assigned to the teams in the league for subsequent fantasy drafts is fourteen in a second season, twelve in a third season, and ten in a fourth season.

9. The method of claim 6, wherein a number of roster positions on each roster is twenty-two.

10. The method of claim 9, wherein the roster positions on each roster are based on football formations.

11. The method of claim 10, wherein the formations include offensive and defensive formations, the offensive formations including an I-formation, a spread formation, and dual tight end formation, and the defensive formations including a 4-3 formation, a 3-4 formation, and a nickel formation.

12. The method of claim 10, wherein players in the league are ranked based on the roster positions, and the score calculated for each team is based at least in part on rankings of the players on the roster.

13. The method of claim 12, wherein a bonus is awarded to a general manager for a player on the roster that is drafted at a pick below a predetermined threshold that also has a player performance ranking above a predetermined threshold.

14. The method according to claim 1, wherein a bonus is awarded to a general manager for a player on the roster that receives an actual professional sport award.

15. The method according to claim 1, wherein the score is calculated based on head to head matchups between teams in the league.

16. The method according to claim 1, wherein the score is calculated based on a team's performance as compared to all other teams in the league.

17. A system for presenting a fantasy sports game, the system comprising:
a server including at least one processor and at least one memory, the memory comprising at least one database storing game data, said game data comprising statistical data input from a third-party data source for performance of players in a professional sports league;
at least one presentation device, the presentation device being communicatively coupled to the server to provide input to the server and receive game information from the server via a network, the presentation device comprising at least one input device, at least one display, at least one processor, and at least one memory;
machine readable instructions stored on at least one of the server and the at least one presentation device, which when executed by the processor of the presentation device or the server, cause the system to
establish at least one league for a fantasy sports game, the league having a predetermined number of teams to participate in the league;
receive requests from fantasy general managers to participate in the league;
assign teams from the predetermined number of teams to the general managers;
identify players that are participating in a professional sport draft as eligible players to be selectable in a fantasy draft for the league;
define a draft order, the draft order comprising a sequence of draft picks assigned to the teams in the league; and
conduct via input received from the presentation devices the fantasy draft, the general managers picking players from the eligible players with the assigned draft picks to form team rosters, the fantasy draft being conducted prior to the professional sport draft.

18. The system of claim 17, wherein a season in the league for the fantasy sports game is conducted based on the rosters formed from the fantasy draft, and wherein the fantasy sports game is played over a plurality of seasons, and prior to each season, an additional fantasy draft is conducted prior to the professional sport draft for that season.

19. A system for presenting a fantasy sports game, the system comprising:
a server including at least one processor and at least one memory, the memory comprising at least one database storing game data, said game data comprising statistical data input from a third-party data source for performance of players in a professional sports league;
at least one presentation device, the presentation device being communicatively coupled to the server to provide input to the server and receive game information from the server via a network, the presentation device comprising at least one input device, at least one display, at least one processor, and at least one memory;
machine readable instructions stored on at least one of the server and the at least one presentation device, which when executed by the processor of the presentation device or the server, cause the system to
establish at least one league for a fantasy sports game, the league having a predetermined number of teams to participate in the league;
receive requests from fantasy general managers to participate in the league;
assign teams from the predetermined number of teams to the general managers;
identify players that are participating in a professional sport league as eligible players to be selectable in a fantasy draft for the league;
define a draft order, the draft order comprising a sequence of draft picks assigned to the teams in the league;
conduct via input received from the presentation devices the fantasy draft, the general managers picking players from the eligible players with the assigned draft picks to form team rosters; and
conduct a season of fantasy league play to calculate a score for each general manager, the score being based on the statistical data;
wherein the fantasy sports game is played over a plurality of seasons, and prior to each season, an additional fantasy draft is conducted, and
wherein after a predetermined number of seasons, players on the rosters of the teams are retired based on whether the players meet an established performance threshold.

20. The system of claim 19, wherein the eligible players to be selectable in a fantasy draft for the league comprise only players that have declared for a professional league draft, and the fantasy draft is conducted prior to the professional draft each season.
